(19) United States
(12) Patent Application Publication
(10) Pub. No.: US 2004/0048747 A1
(43) Pub. Date: Mar. 11, 2004

(54) Product formulation and method of its application for increasing the efficiency of systemic herbicides

(76) Inventors: Jan Netland, As (NO); Knut Kristian Osnes, Skien (NO); Henrik Hoyvik, Skien (NO)

Correspondence Address: WENDEROTH, LIND & PONACK, L.L.P., 2033 K STREET N. W., SUITE 800, WASHINGTON, DC, 20006-1021, US

(21) Appl. No.: 10/451,428

(22) PCT Filed: Dec. 19, 2001
(86) PCT No.: PCT/NO01/00500

(30) Foreign Application Priority Data
Dec. 22, 2000 (NO) 20006617

(51) Int. Cl. A01N 37/00

(52) U.S. Cl. 504/142

(57) ABSTRACT

The present invention relates to a product formulation and a method of its application of reducing the amount of systemic herbicide needed for weed control. The product formulation comprises a systemic herbicide and at least one disalt of formic acid. Useful herbicides are glyphosate, imazapyr, and rimsulphuron. The most preferred salt is potassium diformate. The product formulation is applied to plants in amounts of 1-25 litres per decar.

The present invention relates to a product formulation and a method of its application of reducing the amounts of systemic herbicides needed for weed control. The method comprises features for special applications of the product in order to obtain desired effect.

The efficacy of systemic herbicides depends on the uptake and transport of said herbicide throughout the weed organisms, hence the name “systemic”.

Agriculture in the developed world is a highly intensive business where the main goal is to produce as much food as possible per area. To reach this goal the agriculture is heavily dependent on the use of different types of chemical input factors like fertilisers and pesticides to improve yield and performance and to reduce yield loss due to weed growth and different types of pests and diseases. In horticulture and gardening similar input factors are employed to achieve similar high quality crop performance.

Increasingly efficient herbicides have been developed by the agrochemical industry during the last decades to be used in various segments of agriculture, horticulture and gardening to reduce weed growth and thereby improve crop yield and crop performance.

Two basic types of herbicide treatment can be distinguished:

1. Total or non-selective treatments have the objective of killing all the vegetation present, for example on railway tracks, garden paths, roads and industrial sites.

2. Selective treatments are intended to suppress or kill some plants without seriously effecting others, thus showing selectivity between the weeds and the crop.

Both kinds of treatment may involve application to the foliage of the plants or to the soil in which they are germinating and growing.

Foliage Treatments

Foliage treatments are subdivided according to the manner in which plants are affected. Contact herbicide affects only the part of the plant receiving direct treatment with the herbicide. A translocated or systemic herbicide is one, which after entering the plant is transported within it and affects sites elsewhere like in shoots or roots. This herbicide acts rather slowly.

Soil Treatments

A residual or soil acting herbicide persists in the soil for a greater or a lesser period and as soon as a seed germinates the herbicide enters the plant and kills it. The herbicide also can enter established plants through its rooting system and be translocated to the active sites. Such herbicides used to be popular to control weeds in non-cropped area, but frequently they leach to the ground water and the most mobile are banned for environmental reasons.

The weeds can be annual or perennial. Annual weeds germinate in the spring or early summer in time to set seed before winter. Some species germinate all through the summer and the late germinating individuals are able to survive winter and continue to grow and set seed next year. If the leaves and stem of an annual weed are destroyed, the whole plant will die. These species can easily be controlled with a contact acting herbicide provided it is satisfactorily covered with the chemical.

Perennial weeds do not set seeds their first growing season. They form an extensive root system or under ground creeping stems (rhizomes) where food reserves are stored. These species are thus able to survive through winter and develop new aerial shoots in spring. The plant can be totally defoliated and all superficial plant material can be removed, but still be able to continue to grow. An established perennial weed is thus difficult to control with a contact acting herbicide. With a systemic herbicide, which is translocated in the plant, these weeds can easily be controlled.

The main problem related to use of herbicides is their potential pollution of the environment. In some cases they lack the necessary selectivity resulting in damage not only to the weeds, but also to some extent damage of the desired crop.

From the patent application EP 0945065A1 it is known crop selective herbicides comprising a first component a) having herbicidal activity selected from the group consisting of glyphosate and the like and a second component b) selected from the group consisting of phosphorous acid derivatives and may further comprise a third component selected from maleic hydrazide. The objective of this application is to improve the selectivity of the herbicide preparations. However, the environmental profile of the herbicide preparations is not improved, as generally three active ingredients are mixed together.

From the patent application EP 566648 it is further known an agricultural herbicidal composition comprising glyphosate or its salt and a 5-16 Carbon, optionally saturated, fatty acids or mixtures of fatty acids and their salts. The ratio a) to b) should be 1:10-10:1, preferably 1:5 to 5:1 and the pH of the preparation should be close to neutrality (pH 6.8-7).

U.S. Pat. No. 6,083,875 relates to solid glyphosate formulations and describes in general terms glyphosate formulations containing salts of organic acids. It is mentioned that one may combine glyphosate in its acid form with a suitable acid acceptor known in the art, and soduim formate is listed among possible acceptors.

The main object of the invention was to arrive at an agricultural composition for weed control which should contain relatively small amounts of herbicides and thereby be more environmentally friendly than the commonly used herbicides. However, the weed controlling effect should be maintained.

Another object of the invention was to obtain reduced application of systemic herbicides in formulations including components known to be agriculturally and environmentally acceptable.

A further object of the invention was to provide a method for improving the efficacy of systemic herbicides so that reduced pesticide applications can be met without reduced crop performance.

The inventors first looked at possible environmentally inert components which could be combined with a herbicide. It was desired that such components could have at least some weed control properties. The inventors decided to test some of the active components used as preservatives, for instance for grass and various crops. The formate salts and especially diformates have proved to be effective preservatives for several crops and feed products. It was then decided to mix potassium diformate with the known herbicide glyphosate. It was then surprisingly found that combining a low rate of a systemic herbicide, like glyphosate with a high profile environmentally inert chemical like formic acid based salts, the latter increased the effect of the herbicide. Initial tests showed that such a mixture could reduce the need for systemic herbicide applications by up to 90% of recommended rate.

Useful cations include sodium, ammonium and potassium. It is within the scope of the invention that the mentioned organic salts are adjusted to a sufficiently acid pH. Therefore the acid to base ratio of the organic salts should be 1 or higher. Examples of useful systemic herbicides include glyphosate, imazapyr and rimsulphuron and their derivatives.

The objects of the invention are achieved by the product and the method according to the attached claims. The product formulation according to the invention comprises a systemic herbicide and at least one disalt of formic acid. The method for improving the effect of systemic herbicide comprises application of the product according to the invention to the plants in amounts of 1-25 litres per decar (10³ m²). The amount applied per decar (10³ m²) will depend on the actual use, such as types of plants to be treated, total or non-selective treatments or selective treatments. The special and preferred features of the invention are as stated in the dependent claims.

The invention is further described and elucidated in the following examples.

### EXAMPLE 1

This example shows the effect of applying a product comprising combinations of glyphosate and potassium diformate.

The aim of this experiment was to investigate if a small dose of glyphosate, a foliage applied systemic herbicide, could extend the herbicide effect of potassium diformate. This is in particular important in perennial weeds, but also to have a complete kill of annual weeds.

Description of the Experiment:

Control of annual weeds will be essential in garden paths, roads, roadsides and other areas covered with gravel, bricks or flag stones. The weed must be totally killed since there is no competition from crop plants like in crop use situations. The aim of the experiment in greenhouse was to find methods to have optimal herbicide effect of K-diformate on different weed species and rape, which served as a model weed.

Seeds were sown in trays, and 2 seedlings were transplanted to 12 cm pots. The soil used was a mixture of 84% sphagnum, 10% sand and 6% clay. The pH was 5.8 and the soil was amended with balanced nutrients.

Greenhouse Conditions:

The temperature was set to 20° C. for 16 hours, 14° C. for 8 hours, but it varied ±3° C. Light period followed the natural day lengths, but artificial light was supplied 16 hours per day.

A wetting agent (0.1%) was used in order to secure complete contact with the plants to be treated. The wetting agent reduces the surface tension of the droplets and results in greater adhesion with the leaf surface and less bounce and roll-off, and a greater part of the leaf area is covered with the herbicide. This is important with contact acting herbicide. The active ingredient was isodecylalcoholethoxsilate (alpha-isodecyl omega-hydroxypoly oxyetylene).

The spray applications were performed with an experimental pot sprayer type (“Flakkebjerg”) pre-set to spray the exact volume. The pressure was 2 bars (105 Pa) and 110° flat fan nozzles (Hardi 411014) were used.

Assessment:

Damage or injury of the plants was visually assessed after the following scale:

| | |
|---|---|
| 9-10: | All the leaves were damaged including the youngest. All aerial |
| | plant parts were dead. |
| 7-8: | The youngest leaf was partly damaged, the rest of the leaves |
| | were damaged. |
| 5-6: | The second youngest leaf was partly damaged, the youngest leaf |
| | more or less intact. |
| 3-4: | The third youngest leaf was partly damaged, the two youngest |
| | leaves more or less intact. |
| 1-2: | Only a small part of leaf area was damaged. |
| 0: | Unharmed plant. |

At the end of the experiment period the plants were harvested and weighed.

Experimental Factors and Layout:

Dose rate of potassium diformate (50% weight/volume): 0-60 and 120 litre per hectare (10⁴ m²).

Dose rate of glyphosphate (36% w/v): 0-300 and 900 ml per hectare (104 m²).

Normal dose rate is 3000 ml per hectare (104 m²).

Total spray volume: 500 litre per hectare (104 m²).

Two Weed Species:

1. Dandelion (Taráxacum cordátum). The plants were grown from seeds and had a rose

2. Poa annua. The plants were grown from seeds and had 34 side shoots when sprayed

Assessment

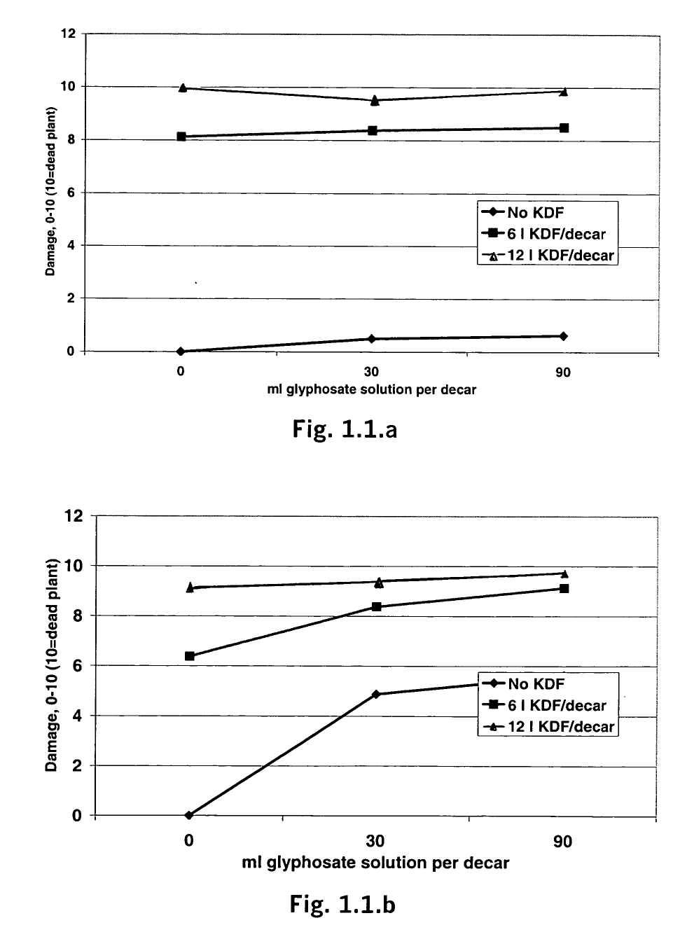

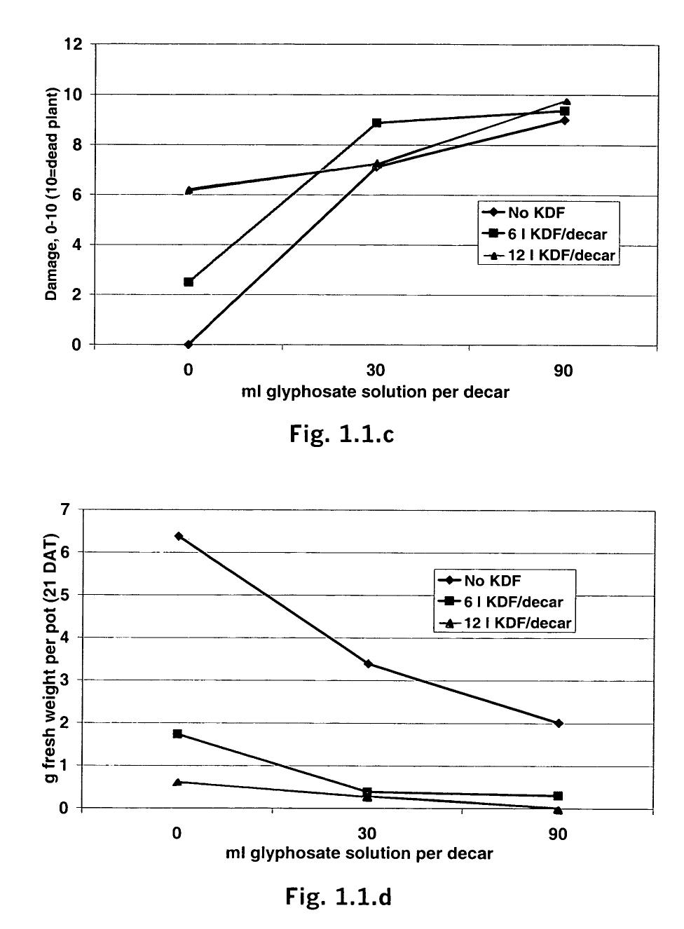

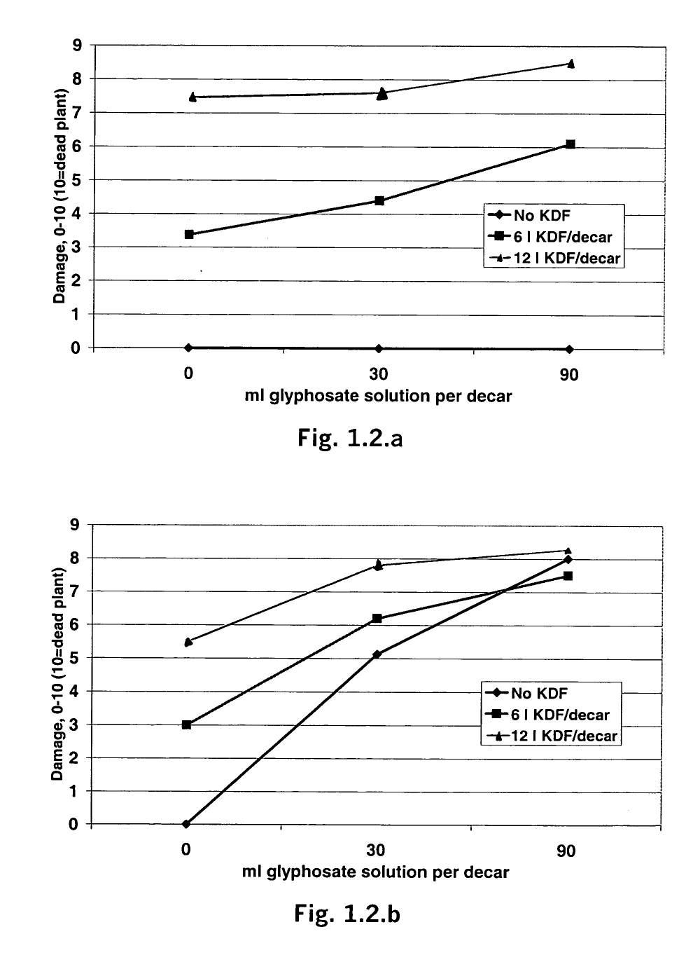

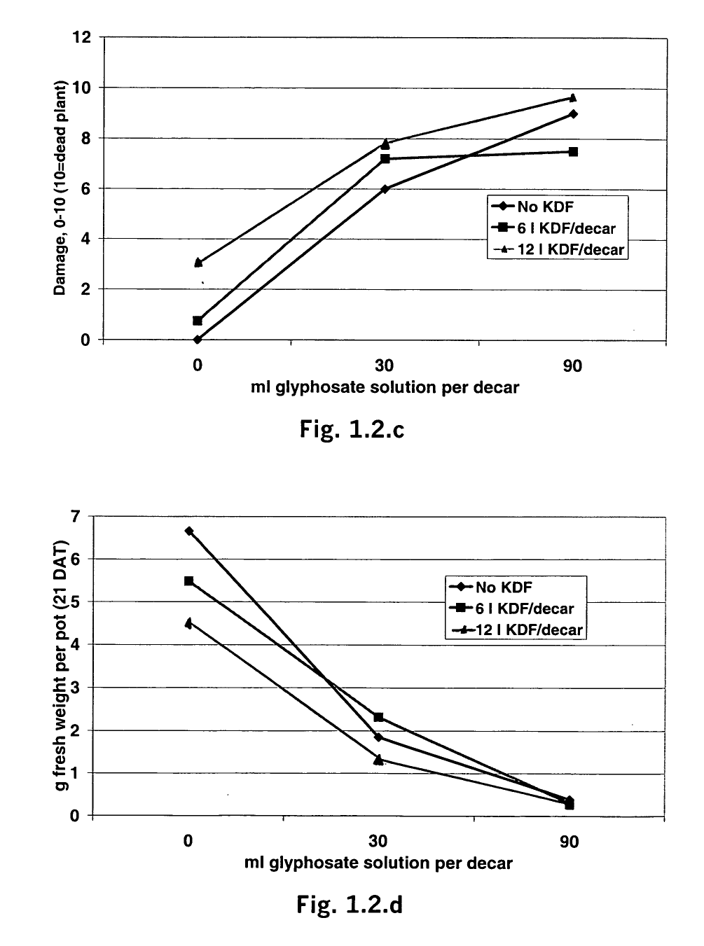

Visual damage assessments are shown in FIG. 1.1. Number of replicates was 8 pots per treatment.

FIG. 1.1a shows the effect 3 days after treatment (DAT).

FIG. 1.1b shows the effect 10 days after treatment (DAT).

FIG. 1.1c shows the effect after 21 days after treatment (DAT).

FIG. 1.1d relates to fresh weight 21 days after treatment (DAT).

### R sults:

FIG. 1.1 demonstrate how fast potassium diformate destroys plant tissue. These figures further show the effect of potassium diformate (50% w/v) and glyphosate (360 grams/litre) combinations on dandelion. Three days after spraying there were no green dandelion leaves when 12 litres of the product according to the invention had been applied. The damage assessments refer to aerial plant material. Value 10 does not necessarily mean that the whole plant is dead. Then the regrowth started, and 21 days after treatment the plants were almost half the size of a non-treated plant. The same tendency is also for Poa annua (FIG. 1.2). These figures further show the effects of potassium diformate (50% w/v) and glyphosate (360 gram/litre) combinations on Poa annua. The results are shown in:

FIG. 1.2a which shows the effect 3 days after treatment (DAT).

FIG. 1.2b which shows the effect 10 days after treatment (DAT).

FIG. 1.2c which shows the effect 21 days after treatment (DAT).

FIG. 1.2d which relates to fresh weight 21 days after treatment (DAT).

### CONCLUSION

The interesting point is how fast and lasting effect of the potassium diformate/glyphosate combinations are. The injury of leaves by potassium diformate did not appear to reduce the uptake and systemic effect of glyphosate. The combination of 6 litres of potassium diformate with 30 ml of glyphosate per decar (10³ m²) gave a fast and lasting effect particularly on dandelion but also on Poa annua.

The effect of glyphosate alone was much slower and very much less efficient.

### EXAMPLE 2

This example shows the combined effect of diformates at different rates and systemic herbicides including glyphosate.

Potassium diformate has been observed to have a dessicating effect on plant leaves. However, regrowth is starting immediately after treatment, and by including the treatment with reduced levels of systemic herbicides a more persistent effect can be achieved and regrowth is comparatively reduced.

Methods:

Potassium diformate combined with glyphosate in greenhouse experiments at the following doses:

K-diformate: 0-0.75-1.5-3.0-6.0 litres per decar (10³ m²) of a 50% w/v solution.

Glyphosate: 0-15-30-60-90 ml per decar (10³ m²) of a 360 gram/litre solution.

Weed Species

The investigations were made on dandelion (Taraxacum cordátum Palmgr.) and Poa annua.

Adjuvant 0.1 and 0.2% wetting agent.

The herbicide, the potassium diformate and the adjuvant were mixed before spraying and applied at a calculated volume of 50 litres per decar (10³ m²).

Greenhouse conditions: 20° C. for 16 hrs, 14° C. for 8 hrs. Day length: 16 hrs artificial light. Experimental conditions were 6 parallel pots and two replicates (at different times).

Observations:

Assessments of damage (necrosis) at 3, 10 and 21 days after treatment (DAT). Fresh weight analysed 28 days after treatment (DAT).

Results:

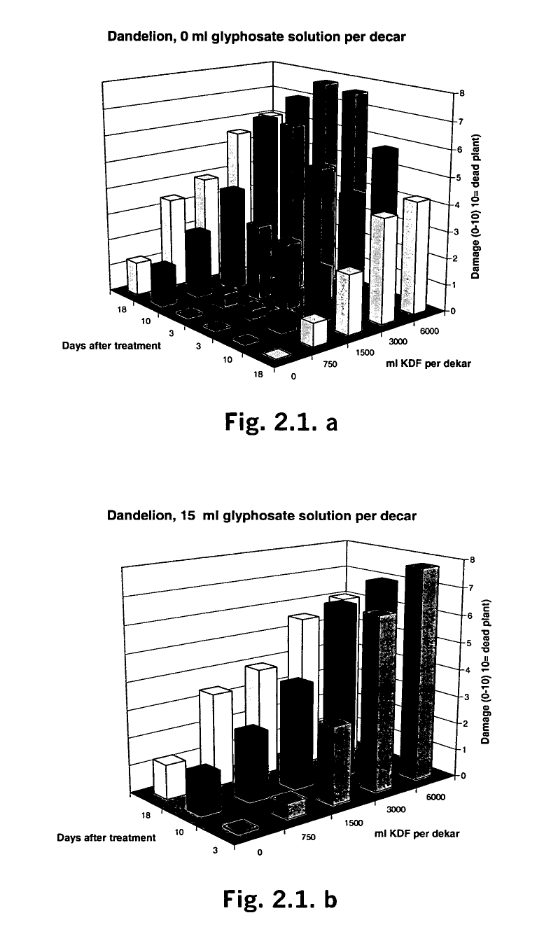

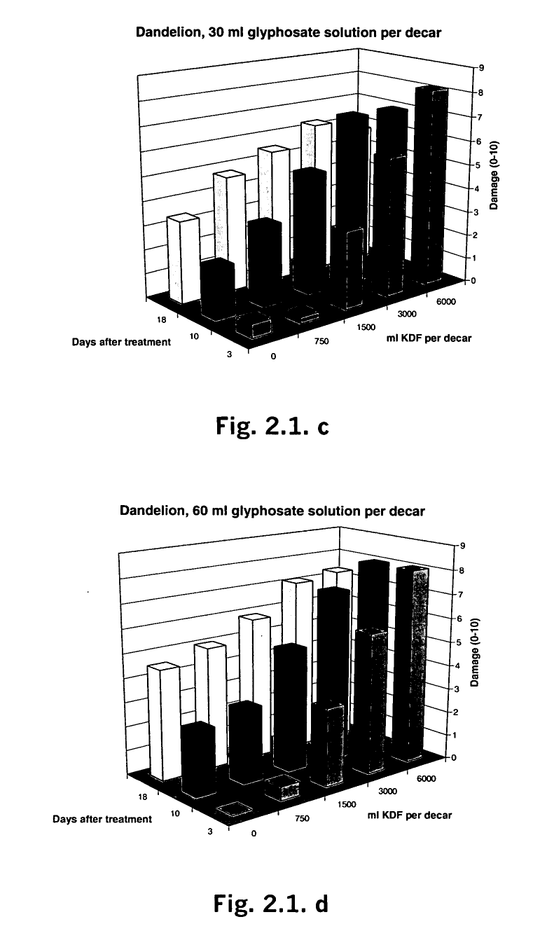

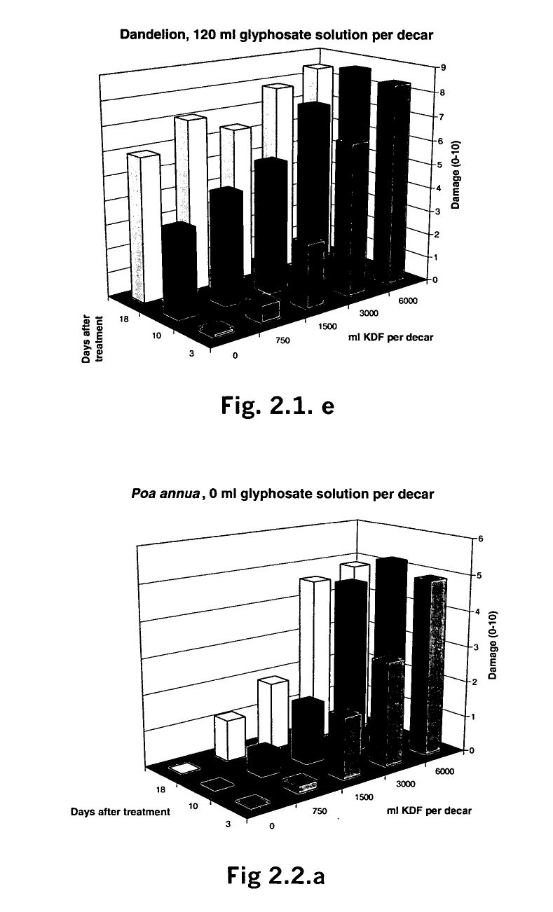

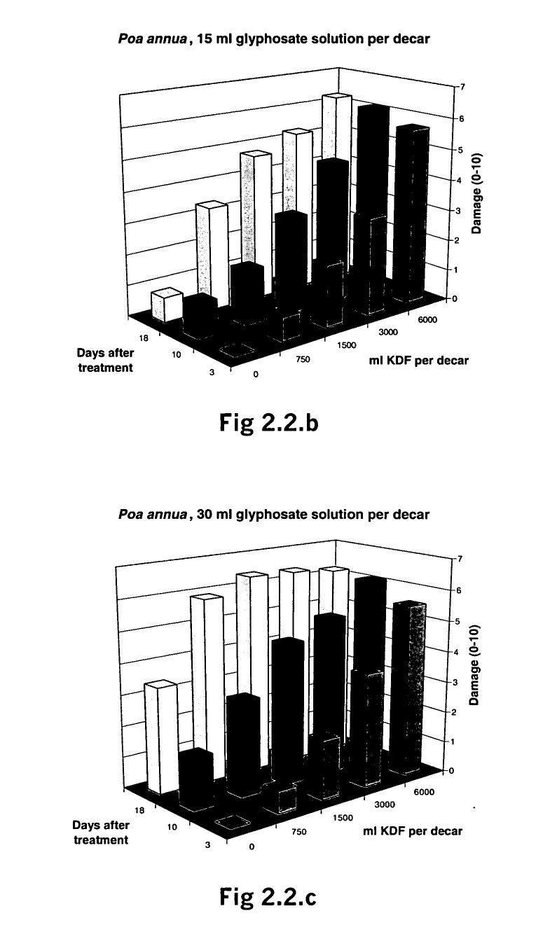

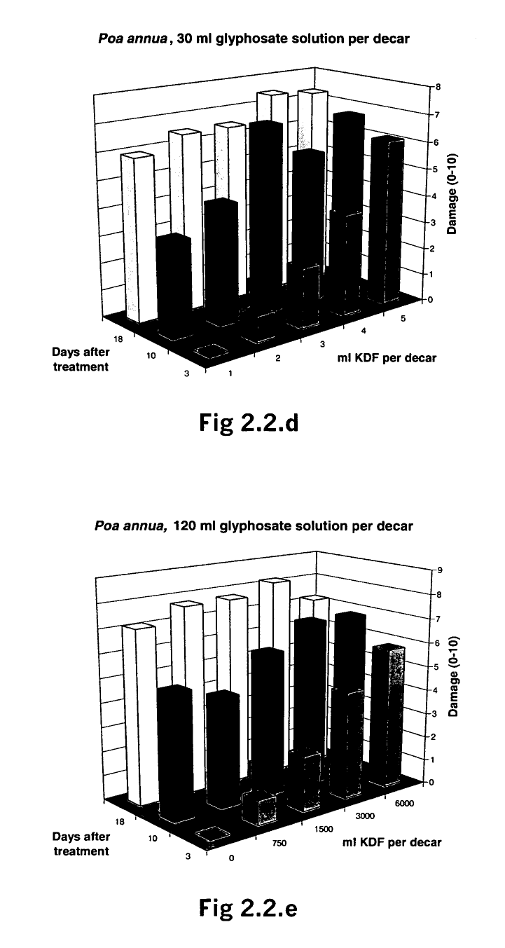

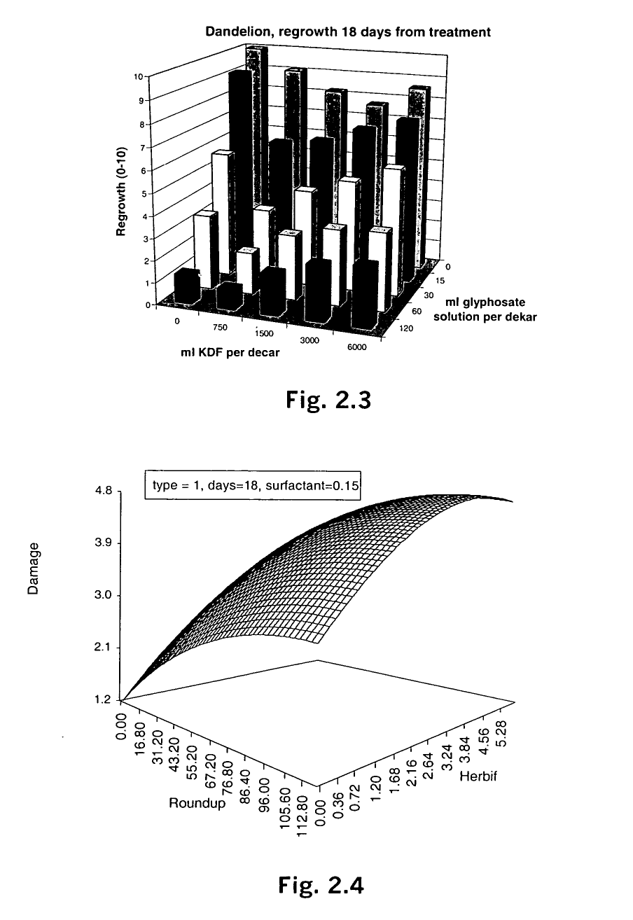

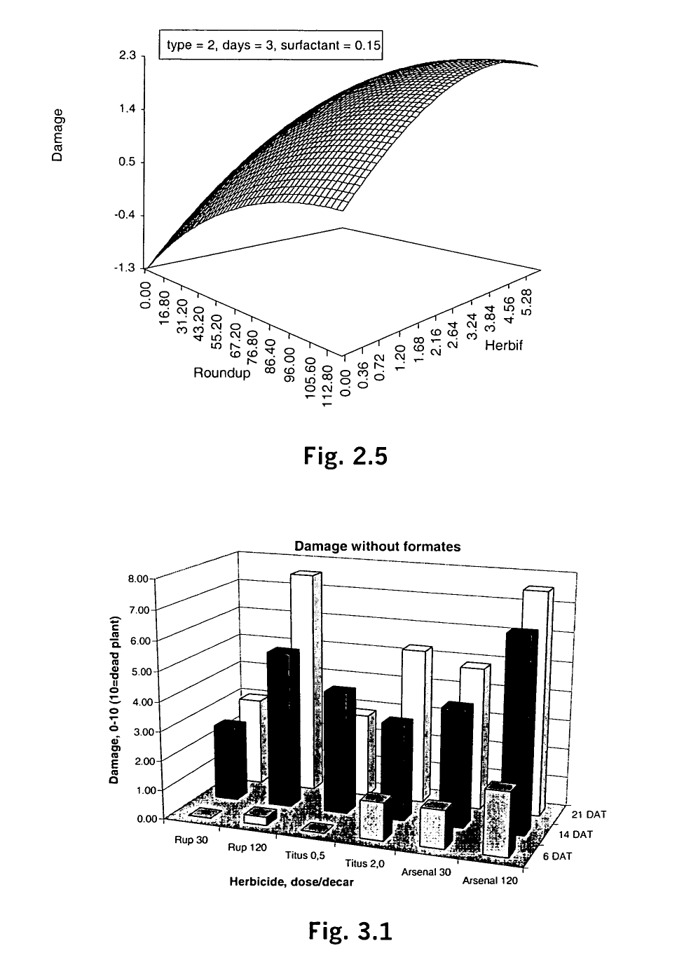

The results from combining potassium diformate and glyphosate are shown in the FIGS. 2.1 to 2.5.

FIGS. 2.1a-e show the combined effects of potassium diformate (50% w/v) as ml per decar (10³ m²) and glyphosate (360 gram/litre) on dandelion grown in pots in greenhouse. Bars are showing plant damage on a scale from 0 (undamaged) to 10.

FIGS. 2.2a-e show the combined effects of potassium diformate (50% w/v) and glyphosate (360 g/litre) on Poa annua grown in pots in green-house. Bars are showing plant damage on a scale from 0 (undamaged) to 10.

FIG. 2.3 shows the combined effect of potassium diformate (50% w/v) and glyphosate on dandelion regrowth. Bars are showing plant regrowth on a scale from 0 to 10 of which 0 is no regrowth and 10 is undamaged control.

FIG. 2.4 shows the combined effect of potassium diformate (50% w/v) (Herbif) (values in litres per decar (10³ m²)) and glyphosate (360 gram/litre) (glyphosate solution in ml per decar (10³ m²)) on dandelion grown in pots in greenhouse 18 days after treatment. Ordinate values are com-paring relative plant damage.

FIG. 2.5 shows the combined effect of potassium diformate (50% w/v) (Herbif) (values in litres per decar (10³ m²)) and glyphosate (360 gram/litre) (glyphosate solution values in ml per decar (10³ m²)) on poa annua grown in pots in greenhouse 3 days after treatment. Ordinate values are comparing relative plant damage.

### EXAMPLE 3

This example shows the combined effect of selected formates and selected systemic herbicides. The main purpose of this example was to investigate if this rapid and lasting weed control experienced in Example 1 is a general effect of mixtures between formates and systemic herbicides.

Methods:

Formates applied in the investigation:

Potassium diformate in a 50% water/volume solution (coded K-diform in the enclosed graphs). Potassium formate (50% w/v) (coded K-form in the enclosed graphs). Solid calcium formate solid was dissolved in water and coded Ca-form in the enclosed graphs. Dose rates applied were: 0 and 3000 ml (g) per decar (10³ m²).

The following systemic herbicides were investigated:

“Roundup Bio” (360 gram/litre glyphosate), “Arsenal 250” (250 gram/litre imazapyr) and “Titus” (250 gram/kg rimsulfuron). The herbicides were applied at dose rates: 10%-40% of full rate:

| “Roundup EC” | “Titus” | “Arsenal 250” |
|---|---|---|
| 30 ml per decar | 0.5 gram per decar | 30 ml per decar |
| (10³m²) | (10³m²) | (10³m²) |
| 120 ml per decar | 2.0 gram per decar | 120 ml per decar |
| (10³m²) | (10³m²) | (10³m²) |

Adjuvant: 0.1% wetting agent (“DP-spredemiddel”)

The formates, herbicides and adjuvants were mixed before spraying and applied at a calculated spray volume of 50 litre per decar (10³ m²). Seven pots were given each treatment.

Weed:

The investigations were done on dandelion (Taraxacum cordátum Palmgr.):

The dandelion seeds were sown June 20 and transplanted to 13 cm plastic pots, one plant per pot. The plants were raised in a greenhouse. The spraying was carried out August 1 and the plants kept in greenhouse until harvest. Greenhouse conditions: 20-25° C. in 16 hrs, 14° C. in 8 hrs. Day length: 16 hrs artificial light.

Observations:

Assessments of damage (necrosis): 6, 14 and 21 days after treatment (DAT). Regrowth and fresh weight were assessed 21 days after spraying.

Results:

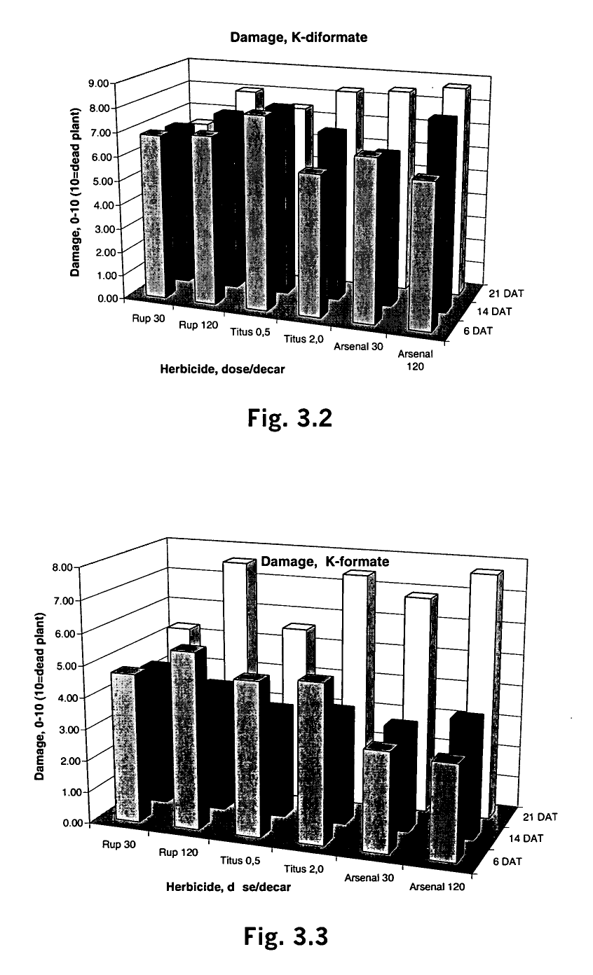

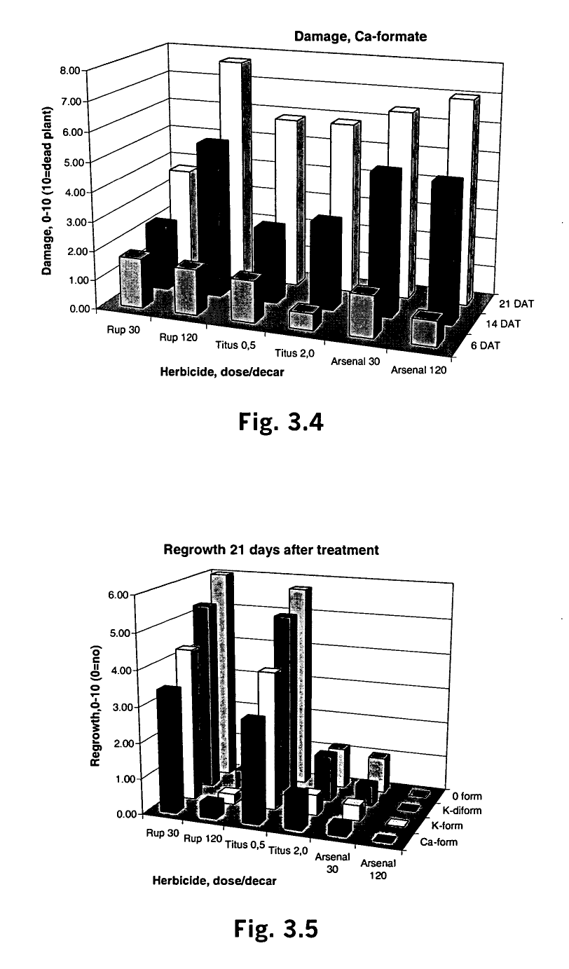

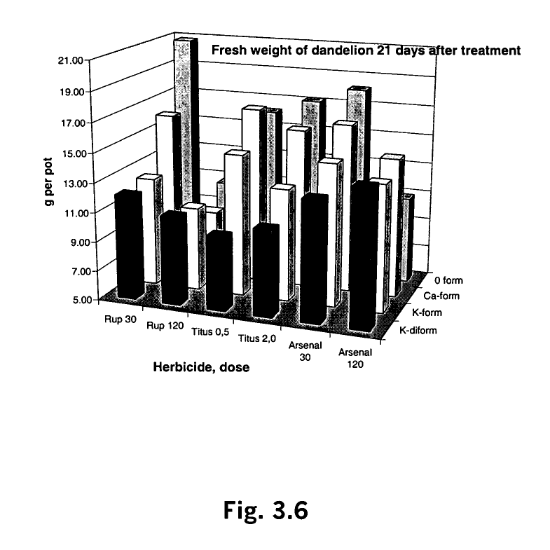

The results are shown in FIGS. 3.1-3.6. As in earlier trials, K-diformate desiccated the leaves quickly (FIG. 3.2). The K-formate was less effective (FIG. 3.3) than the diformate as reported earlier (Experiment 1). Ca-formate was even less effective than K-formate (FIG. 3.4). FIG. 3.1 shows that the effect of herbicide alone was slower than the K-diformate mixtures. This figure further shows the combined effect of three different systemic herbicides applied at 10% and 40% of recommended rate. In the figure Rup=glyphosate, 360 gram/litre, (Rup 30 and Rup 120 are 30 and 120, respectively). “Titus”=rimsulfuron 250 gram/kg. “Titus” 0.5 and “Titus” 2 are 0.5, 1 and 2.0 gram/decar (10³ m²), respectively) “Arsenal”=imizapyr 250 gram/litre (“Arsenal” 30 and “Arsenal” 120 are 30 and 120 ml per decar (10³ m²), respectively.

FIG. 3.5 shows that the regrowth after “Arsenal” was very limited even at the lowest dose rate. The regrowth was also very little affected by mixing with formates. The highest dose rates of “Roundup” and “Titus” follow the same pattern. This figure further shows the combined effects of different formates (Ca-formate, K-Formate and K-diformate) applied at 3 litres (1.5 kg) per decar (10³ m²) and different systemic herbicides on dandelion. The important result in these cases is that mixing with formates did not significantly increase the regrowth. At the lowest dose rates of “Roundup” and “Titus”, mixing with formates quite obviously decreased regrowth compared with the systemic herbicide alone. However, the regrowth was higher after mixing with K-diformate than mixing with Ca- or K-formate. This might be an effect of the rapid desiccation by K-diformate.

The fresh weight measurement in FIG. 3.6 supports the result from the regrowth assessments. The differences in fresh weight between the treatments are not so big, however. This figure further shows the combined effect of different formates (Ca-formate, K-formate and K-diformate) applied at 3 litres (1.5 kg) per decar (10³ m²) and different systemic herbicides on dandelion.

FIG. 3.1 shows a control experiment: Damage 6, 14 and 21 days after spraying with herbicides. No formates were added.

FIG. 3.2 shows damage 6, 14 and 21 days after spraying. Herbicides were mixed with potassium diformate.

FIG. 3.3 shows damage 6, 14 and 21 days after spraying. Herbicides were mixed with potassium formate

FIG. 3.4 shows damage 6, 14 and 21 days after spraying. Herbicides were mixed with Ca-formate.

FIG. 3.5 shows regrowth 21 days after spraying.

FIG. 3.6 shows fresh weight of dandelion 21 days after treatment.

### CONCLUSIONS

The results demonstrate that K-diformate mixed with a systemic herbicide gives a quick and lasting control of dandelion under greenhouse conditions. The desiccation effect of the other formates is too weak to give the rapid weed effect.

By the present invention the inventors succeeded in arriving at an improved product formulation and a method giving the following benefits:

When high rates of diformate were included in the product formulation, extremely rapid desiccation of weeds and long lasting effect of weed damage was achieved with reduced levels of herbicides.

When low rates of diformate were included in the product formulation, improved effect of systemic herbicide was obtained at highly reduced herbicide application rates.

Improved environmental profile of weed control was achieved because of the reduced application of herbicides.

The fatty acid salts are lower than that of the above application (EP 566648). To get a sufficiently effective formulation, an essential achievement obtained by the inventors was to increase the ratio free acid and the associated salt. Thereby it was obtained the most effective formulations at a pH value lower than the pKa of the associated acid.

1. A product formulation comprising a systemic herbicide and at least one disalt of formic acid.

2. Product according to claim 1,
characterized in that
the systemic herbicide is glyphosate or its derivatives.

3. Product according to claim 1,
characterized in that
the disalt is potassium diformate.

4. Product according to claim 1,
characterized In that
the molar ratio of formic acid and associated salt is 1 or higher.

5. Product according to claim 1,
characterized in that
the systemic acid is imazapyr or rimsulphuron.

6. Product according to claim 1,
characterized in that
the product contains 1.9-7.5 grams per litre imazapyr.

7. Product according to claim 1,
characterized in that
the product contains 30-125 milligrams per litre rimsulfuron.

8. Product according to claim 1,
characterized in that
the acid/disalt mixture of formic acid is 1-8 moles per litre.

9. Product according to claim 1,
characterized in that
the product contains 2.5-15 grams per litre glyphosate.

10. Product according to claim 1,
characterized in that
the cation of the salt is sodium, potassium or ammonium.

11. Method for improving the effect of systemic herbicides,
characterized in that
a product formulation according to claims 1-10 comprising a systemic herbicide and a disalt of formic acid is applied to the plants in amounts of 1 to 25 litres per decar (10³ m²).
